(19) United States
(12) Patent Application Publication
(10) Pub. No.: US 2008/0189826 A1
(43) Pub. Date: Aug. 14, 2008

(54) Hot mitts

(76) Inventor: George Dilli, Towson, MD (US)

Correspondence Address: Royal W. Graig;Ober, Kaler, Grimes & Shriver, 120 East Baltimore Street, Baltimore, MD, 21202-1643, US

(21) Appl. No.: 12/069,833

(22) Filed: Feb. 13, 2008

Related U.S. Application Data
(60) Provisional application No. 60/900,945, filed on Feb. 13, 2007.

(51) Int. Cl. A41D 19/01; A41D 19/00; H05B 1/00; H05B 3/06

(52) U.S. Cl. 2/158; 2/160; 2/161.2; 219/211; 219/527

(57) ABSTRACT

An electrically-heated golf mitten formed of a three-layer fabric body that encases the thumb separately and the other four fingers together, and including a cut-and-sewn nylon shell, cut-and-sewn closed cell foam insulator, and cut-and-sewn fleece liner. A battery pack is mounted on the wrist, and a Velcro™-attachable elastic cuff-strap is stretched around the wrist and battery pack for securement and sealing. The battery pack is connected to heating elements attached inwardly of the closed-cell foam insulator. In use, the battery pack and heating elements are designed for relatively high heat, and the three-layer fabric body with sealing cuff-strap is designed for high heat retention. The heated mitten is also very easy to put on and take off. Thus, a golfer dons the mitten for 5 minute intervals between strokes for flash warming of the hands.

### CROSS-REFERENCE TO RELATED APPLICATIONS

The present application derives priority from U.S. provisional application No. 60/900,945 filed 13-Feb.-2007.

### BACKGROUND OF THE INVENTION

1. Field of the Invention

The present invention relates to functional clothing and, more particularly, to a battery-heated mitten or “hot mitt” for golfers, to allow them to quickly warm their hands.

2. Description of the Background

There is a huge industry catering to golf enthusiasts. Worldwide, there are 36,000 golf courses, 26 million golfers and 550 million rounds of golf played each year. Most rounds are played during the summer months, or in climates that enjoy year-round warmth. However, some rounds are played by intrepid golfers in the cold. Cold-weather golfers have a hard time focusing on their game when their hands are cold, and tend to lose their feel for the club. A variety of solutions have been proposed for the problem of cold hands. For example, U.S. Pat. No. 2,329,766 to Jacobsen shows an early electrically heated flying suit including gloves.

U.S. Pat. No. 3,292,628 to Maxwell et al. issued December 1966 shows an electrically-heated glove for arthritis or the like. There are no batteries.

U.S. Pat. No. 3,621,191 to Cornwell issued Nov. 16, 1971 shows an electrically heated mitten with an ionomer plastic insulating layer fitted into a mitten and a long stranded heating wire is embedded in a heat-conducting plastic member which is positioned within the insulating plastic cover of the mitten. The wires are connected to a source of low-voltage electricity for resistance heating in order to maintain the handwear at a comfortable temperature.

U.S. Pat. No. 4,087,675 to Sansonetti issued May 2, 1978 shows a heated mitten for use in conjunction with the application of a hand cream. A battery is secured to the outer surface of the outer mitten.

U.S. Pat. No. 4,021,640 to Gross et al. (Comfort Products, Inc.) issued May 3, 1977 shows an insulated glove construction with mesh insulation material extending over the front, back and tip portions of each of the fingers and of the thumb of the glove. Heating means may be provided to warm the tips of the front of the fingers and the tip of the front of the thumb of the glove. Battery means may be carried in the glove body to provide a source of energy for the heating means.

United States Patent Application 20040164066 by Ford et al. published Aug. 26, 2004 shows a battery-heated glove that utilizes an electrically-conductive, all metal mesh fabric for the uniform distribution of heat throughout the surface area of the garment, thus permitting freedom of movement without sacrifice to the structural integrity of the fabric.

In addition, Nordic Gear™ sells battery heated mittens, for example, the LECTRA MITT® item #LM 20 has a durable nylon taslan shell, maxi-grip fingers and snap on/off electric control for easy operation. Nordic Gear P.O. Box 1010 Morrisville, Vt. 05661 US (802) 888-6400. While the foregoing solutions are capable of warming hands, they are not well-suited to doing it in accordance with the demands imposed during a typical round of golf.

It would be greatly advantageous to provide a cost effective, easy to manufacture heated golf mitten incorporating a battery pack and internal heating elements for rapidly warming a golfer's hands between strokes.

### SUMMARY OF THE INVENTION

It is therefore an object of the present invention to provide a heated golf mitten incorporating a battery pack and internal heating elements for rapidly warming a golfer's hands between strokes.

It is another object to provide a heated golf mitten as described above that is lightweight, easy to carry, and which can be quickly put on or taken off between strokes.

In accordance with the foregoing objects, the present invention is a heated golf mitten comprised of a three-layer fabric body that encases the thumb separately and the other four fingers together, and including a cut-and-sewn nylon shell, cut-and-sewn closed cell foam insulator, cut-and-sewn fleece liner. A battery pack is mounted on the wrist, and a Velcro™-attachable elastic cuff-strap is stretched around the wrist and battery pack for securement and sealing. The battery pack is connected to heating elements attached inwardly of the closed-cell foam insulator.

In use, the battery pack and heating elements are designed for high heat, and the three-layer fabric body with sealing cuff-strap is designed for high heat retention. The heated mitten is also very easy to put on and take off. Thus, a golfer dons the mitten for 5 minute intervals between strokes for flash warming of the hands.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a top perspective view of the heated golf mitten 2 according one embodiment of the present invention.

FIG. 2 (A-D) is a composite view of a heated golf mitten 2 as in FIG. 1 illustrating opening of the battery pack 30.

FIG. 3 (A-C) is a composite view of the heated golf mitten 2 as in FIGS. 1-2 illustrating by cross-sections (A-B) how the fabric body is rolls up opening and seals by cuff strap 30.

FIG. 4 is a cut-away view of the heated golf mitten 2 as in FIGS. 1-3 showing the internal heating elements 40.

FIG. 5 is a perspective view of the battery pack 30.

FIG. 6 is a top perspective view of the heated golf mitten 2 showing its advertising space.

### DETAILED DESCRIPTION OF THE PREFERRED EMBODIMENTS

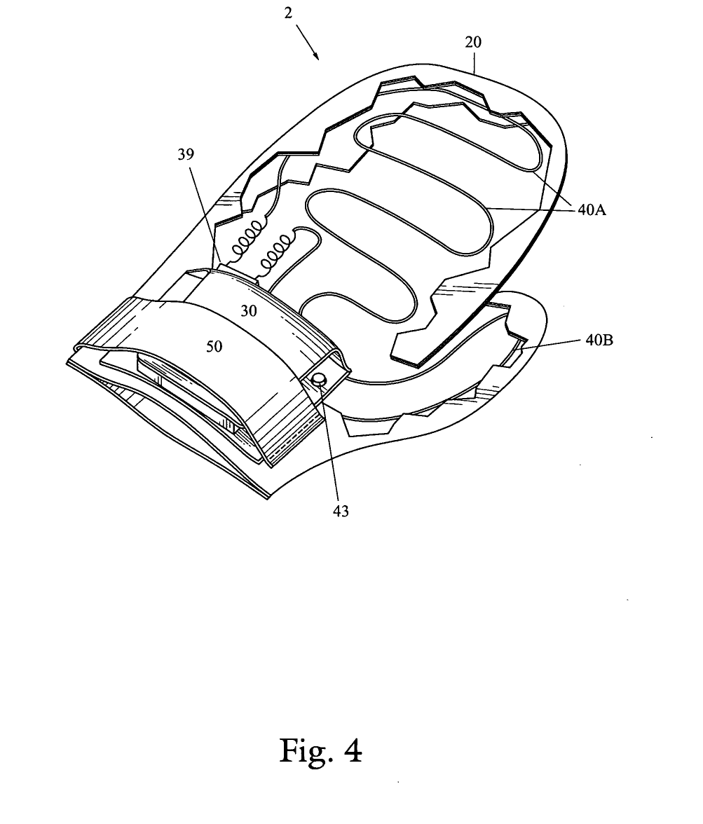

The present invention is a heated golf mitten 2 comprised of a three-layer fabric body 20 conforming to the hand and encasing the thumb separately and the other four fingers together. The fabric body 20 includes a cut-and-sewn nylon shell 22, cut-and-sewn closed cell foam insulator 24, and cut-and-sewn fleece liner 26. These three layers 22-26 may be laminated, stitched, and/or otherwise adhered together. A battery pack 30 is mounted on the wrist, and a Velcro™-attachable elastic cuff-strap 50 is stretched around the wrist and about the battery pack 30 for securement and sealing. The battery pack 30 is connected to heating elements 40 (see FIG. 4) attached inwardly of the closed-cell foam insulator 40. In use, the battery pack 30 and heating elements 40 are designed for generating relatively high heat, and the three-layer fabric body with sealing cuff-strap 50 is designed for good heat retention. The heated mitten 2 is also very easy to put on and take off. This allows golfers to don the mittens for relatively short (five or so) minute intervals between strokes for flash warming of the hands.

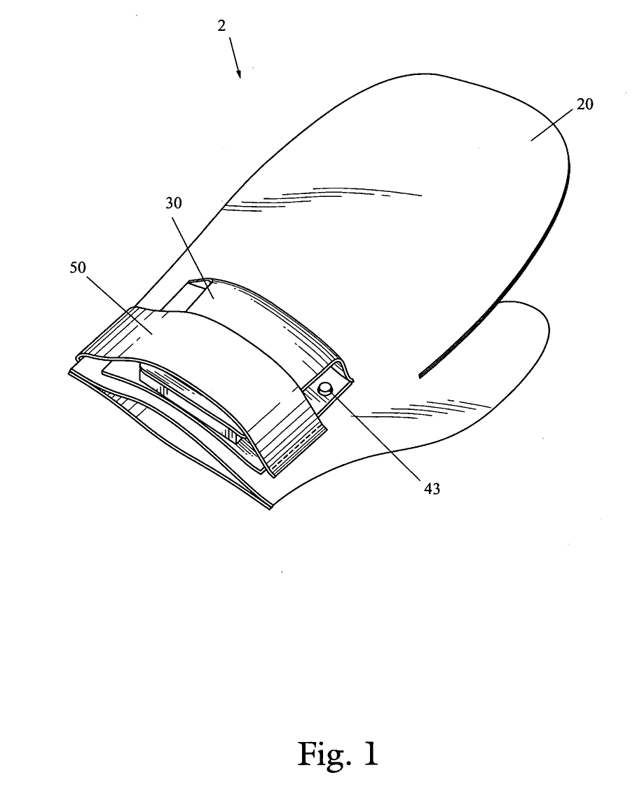

FIG. 1 is a top perspective view of the heated golf mitten 2 according one embodiment of the present invention. The heated golf mitten 2 generally comprises a three-layer fabric body 20 that encases the thumb separately and the other four fingers together, and including a cut-and-sewn nylon shell 22, cut-and-sewn closed cell foam insulator 24 and cut-and-sewn fleece liner 26 (24, 26 not seen in FIG. 1). A battery pack 30 is mounted on the wrist, and a Velcro™-attachable elastic cuff-strap 50 is stretched around the wrist and battery pack 30 for securement and sealing. The battery pack 30 is connected to internal heating elements 40 attached inside the body 20 of glove 2. In use, the battery pack 30 and heating elements 40 generate high heat, and the three-layer fabric body with sealing cuff-strap 50 is designed for maximum insulation and high heat retention. As can be seen, the heated mitten 2 has a wide oversize mouth 27 which makes it very easy to put on and take off. Golfers need only wear the mittens for short (five or so) minute intervals between strokes for flash warming of the hands.

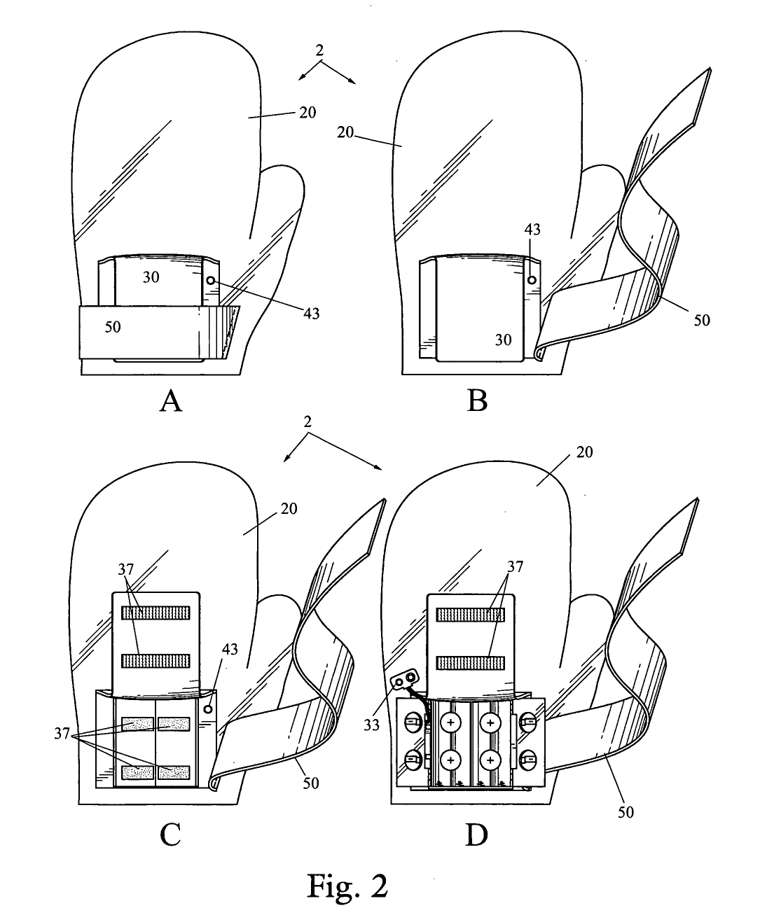

FIG. 2 (A-D) is a composite view of a heated golf mitten 2 as in FIG. 1 illustrating opening of the battery pack 30.

As seen at FIG. 2A, the battery pack 30 is mounted on top of the wrist, and the Velcro™-attachable elastic cuff-strap 50 encircles the wrist and battery pack 30 for securement and sealing. As seen at FIG. 2B, access to the battery pack 30 is gained by removing the elastic cuff-strap 50 from the wrist. The battery pack 30 includes a rectangular enclosure for containing four AA battery cells. The enclosure is formed from a single sheet of thin plastic cut into a cross-pattern and hinged by scoring to provide fold over flaps. The base of the enclosure is secured to the body 20 of glove 2 by pop-rivets or the like. A four AA cell battery tray 32 resides within the battery pack 30 and leads to a standard (±) connector 33. The flaps of battery pack 30 fold overtop the battery tray 32, first two side flaps as seen in FIG. 2C and then a cover flap as seen at FIG. 2B. The side flaps bear Velcro™ patches 37 on top, and the cover flap bears mating Velcro on the bottom. Thus, the flaps of battery pack 30 fully enclose the battery tray 32 and lock together via the Velcro™ patches 37.

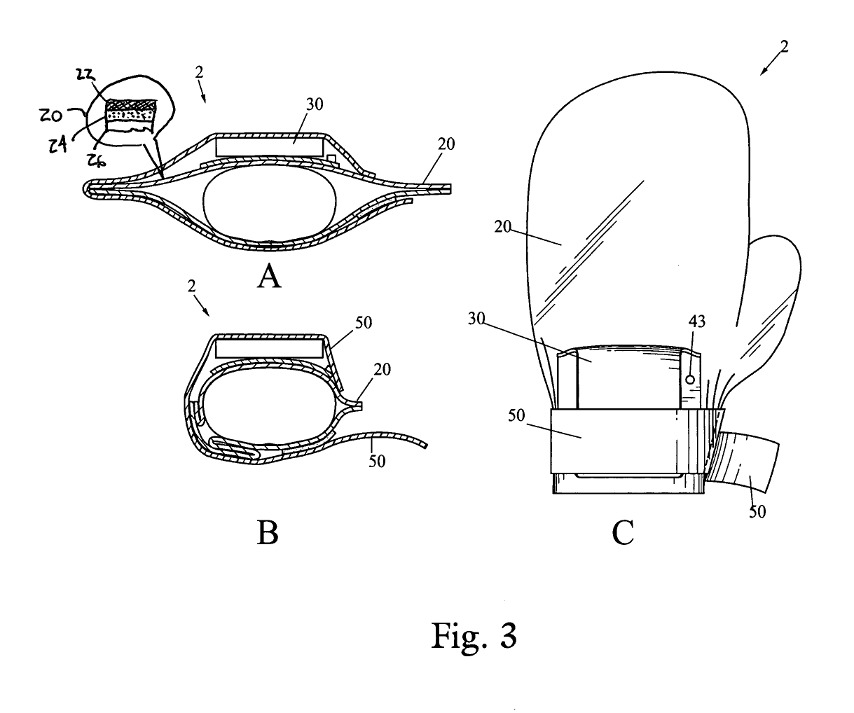

FIG. 3 (A-C) is a composite view of the heated golf mitten 2 as in FIGS. 1-2 illustrating by cross-sections (A-B) how the fabric body 20 rolls up and seals by cuff strap 30. Again, the body 20 is formed from three distinct layers including a cut-and-sewn nylon shell 22, cut-and-sewn closed cell foam insulator 24, and cut-and-sewn fleece liner 26 that encases the thumb separately and the other four fingers together. The heating elements 40 are preferably molded into the closed cell foam insulator 24. Preferably, each layer of nylon shell 22, and fleece liner 26 are formed from two identical mitten patterns cut into a corresponding fabric blank, with closed cell foam insulator 24 likewise being formed from two identical molded mitten patterns. The opposing two layers of each of these three layers is then stitched together about the periphery. The mitten patterns are cut relatively large-sized, in the manner of a potholder glove, with a large opening for easy insertion of the hand. The closed cell foam insulator 24 is inserted into the nylon shell 22, and the fleece liner 26 is inserted into the closed cell foam insulator 24 to form a wide-mouth cross-section as shown in FIG. 3A. The three layers 22-26 may be stitched, laminated or otherwise adhered together.

Battery pack 30 is mounted on the wrist, and Velcro™-attachable elastic cuff-strap 50 is stretched around the wrist and battery pack 30 for securement and sealing. Initially, the mouth 27 of the body 20 is oversized as at FIG. 3A, approximately, twice the diameter of the wrist, and the fabric body 20 and wide-mouth opening protrude outward on opposing sides of the golfer's wrist. This allows a user to very quickly and easily slip their hand inside when desired. However, the elastic cuff-strap 50 wraps 160-180 degrees around the wrist and battery pack 30 and attaches to the body 20. Thus, the cuff-strap 50 wraps around the protruding portions of the fabric body 20 against the golfer's wrist and secures them thereto, while also securing the battery pack. When the cuff-strap 50 is pulled tight it essentially collars the oversize mouth 27 of the body 20 against the wrist as seen at FIG. 3B, thereby sealing the mouth 27 against the cold and elements.

FIG. 4 is a cut-away view of the heated golf mitten 2 as in FIGS. 1-3 showing the internal heating elements 40. The heating elements 40 include a first circuit comprising a series of laterally-extending curvilinear elements 40A embedded (by molding or otherwise) in the foam layer 24 of body 20, and traversing the main hand portion. The heating elements 40 also include one curvilinear loop 40B embedded (by molding or otherwise) in the foam layer 24 of body 20 along the thumb area. The combined resistance of the heating elements 40 is on the order of about 2-3 Ohms, so when powered with four 1.5 volt batteries (6V total), they generate approximately 2-3 watts. In addition, the three-layer fabric body with sealing cuff-strap 50 is designed for high heat retention. The heated mitten 2 is also very easy to put on and take off. Golfers don the mittens for short (five or so) minute intervals between strokes for flash warming of the hands.

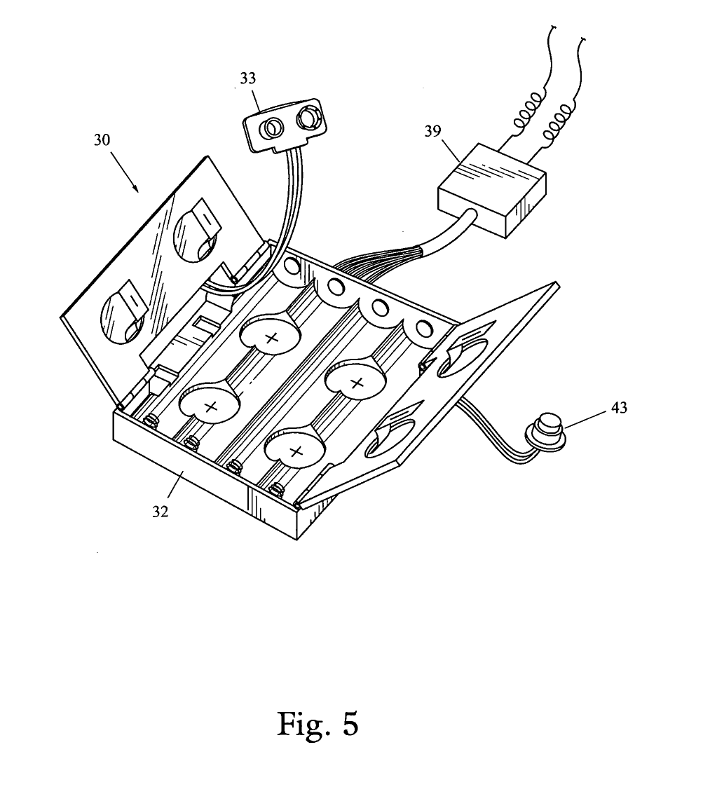

FIG. 5 is a perspective view of the battery pack 30 showing the battery tray 32 connected to a resistive connector block 39. The connector block 39 contains any necessary ballast resistors for the heating elements 40 and also allows direct connection of the heating elements 40 into the connector block 39. The battery tray 32 preferably comprises a conventional four-AA-cell tray with standard (±) connector dongle 33. An on/off detent switch 43 is attached exteriorly of the battery pack 30 for selectively applying/removing power to the heating elements 40.

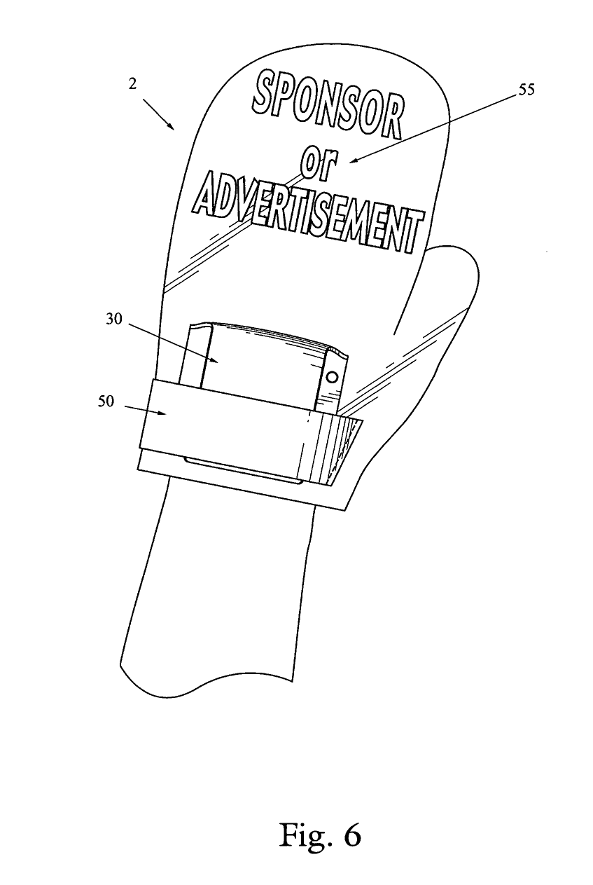

FIG. 6 is a top perspective view of the heated golf mitten 2 showing how it lends itself to advertising by including a large visible advertising space for a logo 55 or other indicia.

It should now be apparent that the above-described heated golf mitten with three-ply construction and incorporating a battery pack and internal heating elements in a closed-cell foam middle layer allows for rapid warming of a golfer's hands between strokes. Moreover, the mittens are lightweight, easy to carry, and can be quickly put on or taken off between strokes, thereby rendering them suitable for flash heating of the hands in a few minute intervals between strokes.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. An electrically-heated golf mitten for heating a golfers hand, comprising:
a fabric body conforming to the hand and including a first portion encasing the thumb separately and a second portion encasing the other four fingers together;
at least one circuitous heating element contained within said fabric body, traversing said first portion, and traversing said second portion;
a battery pack attached to said fabric body exteriorly at the wrist and electrically connectable to said heating element;
a cuff-strap attached at one end to said fabric body, extendable around said battery pack and wrist, and attachable at another end.

2. The electrically-heated golf mitten according to claim 1, wherein said fabric body comprises a three-ply body including a nylon shell, closed cell foam insulator, fleece liner.

3. The electrically-heated golf mitten according to claim 1, wherein said cuff-strap is an elastic strap.

4. The electrically-heated golf mitten according to claim 3, wherein said cuff-strap includes a hook-and-loop patch at said other end.

5. The electrically-heated golf mitten according to claim 1, wherein said elastic cuff-strap stretches substantially 360 degrees about the golfer's wrist.

6. The electrically-heated golf mitten according to claim 2, wherein said heating elements are enbedded inside the closed-cell foam insulator.

7. The electrically-heated golf mitten according to claim 6, wherein said heating elements include a first circuit comprising a series of laterally-extending curvilinear elements traversing the main hand portion.

8. The electrically-heated golf mitten according to claim 8, wherein said heating elements include a curvilinear loop traversing the thumb area.

9. The electrically-heated golf mitten according to claim 8, wherein a combined resistance of the heating elements is approximately 2-3 ohms.

10. The electrically-heated golf mitten according to claim 9, wherein said heating elements generate approximately 2-3 watts of power.

11. The electrically-heated golf mitten according to claim 1, further comprising an on/off switch is attached exteriorly of the battery pack for selectively applying/removing power to the heating elements.

12. The electrically-heated golf mitten according to claim 1, wherein each of said nylon shell, closed cell foam insulator and fleece liner comprise two opposing mitten-shaped sections attached about their periphery except to leave a wide-mouth opening.

13. The electrically-heated golf mitten according to claim 12, wherein said fleece liner is inserted into the closed cell foam insulator, and the closed cell foam insulator is inserted into said nylon shell.

14. The electrically-heated golf mitten according to claim 12, wherein said fabric body wide-mouth opening is approximately twice a diameter of the golfer's wrist.

15. The electrically-heated golf mitten according to claim 14, wherein said fabric body and wide-mouth opening protrude outward on opposing sides of said golfer's wrist.

16. The electrically-heated golf mitten according to claim 15, wherein said cuff-strap wraps the protruding fabric body against the golfer's wrist and secures it thereto.
